(19) United States
(12) Patent Application Publication
(10) Pub. No.: US 2015/0026062 A1
(43) Pub. Date: Jan. 22, 2015

(54) PAYMENT COLLECTION, AGGREGATION AND REALIZATION APPARATUSES, METHODS AND SYSTEMS

(71) Applicant: JETCO Research Inc., Laurel, MD (US)

(72) Inventors: Gaige Bradley Paulsen, Washington, DC (US); Douglas Edward Humphrey, Laurel, MD (US); Joshua A. Duberman, Silver Spring, MD (US); James Stibbards, Herndon, VA (US); Anastasia M. Smith, Laurel, MD (US)

(21) Appl. No.: 14/335,520

(22) Filed: Jul. 18, 2014

Related U.S. Application Data
(60) Provisional application No. 61/958,024, filed on Jul. 18, 2013.

(51) Int. Cl. G06Q 20/22; G06Q 30/02

(52) U.S. Cl. CPC G06Q 20/29; G06Q 30/0279
USPC 705/44; 705/39

(57) ABSTRACT

The payment collection, aggregation and realization apparatuses, methods and systems receive a communication message including a payment indication to transfer a payment amount to a payee; determine the communication message is originated from a user compute device before the user has registered with the payment system; obtain, from the communication message, a reference identifier referencing the user; generate a temporary profile including the reference identifier and information relating to the payment indication; receive, subsequent to receiving the communication message, payment account information of the user after registration of the user with the payment system; and automatically initiate a payment transaction for the payment indication from the temporary profile based on the payment account information.

### PRIORITY CLAIM

This application is a non-provisional of and claims priority under 35 U.S.C. §119 to U.S. Provisional Application No. 61/958,024, filed on Jul. 18, 2013, entitled “JETCO Payment and Donation System.”

This application is related to co-pending Patent Cooperation Treaty International application No. ______, Attorney Docket No. JTCO-001/01WO, filed on the same day herewith, entitled “Payment Collection, Aggregation and Realization Apparatuses, Methods and Systems.”

The aforementioned applications are all herein expressly incorporated by reference.

### FIELD

Some embodiments described herein generally address apparatuses, methods, and systems for online payment, and more particularly, include methods and system for providing micropayment-based donation collection, aggregation and realization.

### BACKGROUND

Online payment systems typically facilitate a user to fulfill a payment to another entity by entering payment information online and sending a transaction request online. When a user wants to make an online payment, such as when the user wants to purchase a product at an online shopping site, the user can login to an online system to proceed with payment. An online payment system typically requires a user to establish an account with the online payment system before the user can initiate a payment transaction request. The user typically registers with the online payment system by manually entering the user's personal information such as a username, user email address, and the user's financial payment information such as a credit card number, at a registration form. After the user has registered, the user can login to the user's registered account to submit a payment via the online payment system.

Known systems for online electronic payments involve a high degree of effort by a user, have expensive fees, and are time-consuming to use. These known systems typically involve the making a number of decisions by the payer or content consumer (hereafter “CC”), possibly including logging into an account and verifying account information, payment origination information and other items. In such online payment systems, users log in to an account, or authenticate themselves, before they are permitted to interact with the payment online system. When the user is not logged in, the user is unknown and is not granted any user-specific rights or authorizations; only when the user is logged in, is the user known and is granted rights on the basis of the system's profile for that user.

### SUMMARY

Some embodiments described herein relate generally to a system for micro-payment donation payment collection and aggregation. In one embodiment, the micro-payment donation system receives, at a payment system associated with a payment widget displayed on a web page, upon engagement of the payment widget by a user, a communication message including a payment indication to transfer a payment amount to a payee. The micro-payment donation system determines that the communication message originated from a user compute device before the user has registered with the payment system. The micro-payment donation system obtains, from the communication message, a reference identifier referencing the user. The micro-payment donation system generates a temporary profile including the reference identifier and information relating to the payment indication. The micro-payment donation system receives, subsequent to receiving the communication message, the payment account information of the user after registration of the user with the payment system. The micro-payment donation system automatically initiates a payment transaction for the payment indication from the temporary profile based on the payment account information.

In some embodiments, the micro-payment donation system receives, via a user compute device, user registration information for a user, the user registration information being associated with a payment system and including user identifying information and user payment account information. The micro-payment donation system retrieves a previously stored temporary profile including a reference identifier that references the user prior to the user being registered with the payment system, and including a payment indication to transfer a payment amount to a payee. The micro-payment donation system correlates the previously stored temporary profile with the user registration information based on a match between the user registration information and the reference identifier. The micro-payment donation system automatically initiates a payment transaction for the payment indication from the temporary profile based on the payment account information.

### BRIEF DESCRIPTION OF THE DRAWINGS

FIG. 1A is a schematic block diagram of a communication network system in which micro-donation functions can be provided, according to an embodiment.

FIG. 1B is a data flow diagram illustrating aspects of interactive data flows between a micro-donation server and related entities, according to an embodiment.

FIG. 2A is a schematic illustration of a micro-donation server, according to an embodiment.

FIGS. 2B-2D are logic flow diagrams illustrating interactions between various functional modules of the micro-donation server for aspects of pre-registration user donation indication processing, temporary profiling and post-registration micro-donation processing, according to an embodiment.

FIG. 3 is a logic flow diagram illustrating aspects of correlating pre-registration user donation indications across different sites, according to an embodiment.

FIG. 4A is a schematic block diagram illustrating aspects of identification module and its interaction with related entities, according to an embodiment.

FIG. 4B is a schematic block diagram illustrating aspects of authentication module and its interaction with related entities, according to an embodiment.

FIG. 4C is a schematic block diagram illustrating aspects of authorizing a transaction request via identification and authentication modules, according to an embodiment.

FIG. 4D is a schematic block diagram illustrating aspects of authorizing a transaction request between two users via identification and authentication modules, according to an embodiment.

### DETAILED DESCRIPTION

In some embodiments, the donation collection, aggregation and realization apparatuses, methods and systems for payments, donations and gratuities (hereinafter “PDGS”) can provide an online electronic network-based transaction method and system for performing payments, donations and gratuities in a micropayment amount. In one implementation, a user can elect to pay for possible associated comments and ratings of all aspects including comments, online content or services performed, payments, gratuities, e.g., by clicking on a payment widget displayed on a payment webpage; in this way, the user need not register with a payment system, and/or a payment website before the user clicks to pay.

Examples of financial transactions implemented via the PDGS include financial gifts, tips, gratuities, payments for goods or services, or payment for the delivery of online digital products, including content such as music, blogs, videos, journalism articles, and articles from scientific and professional journals. The PDGS permits, for example, payments of very low denomination, at very low transactions fees, thus enabling very low denomination transactions to be cost effective or economically viable.

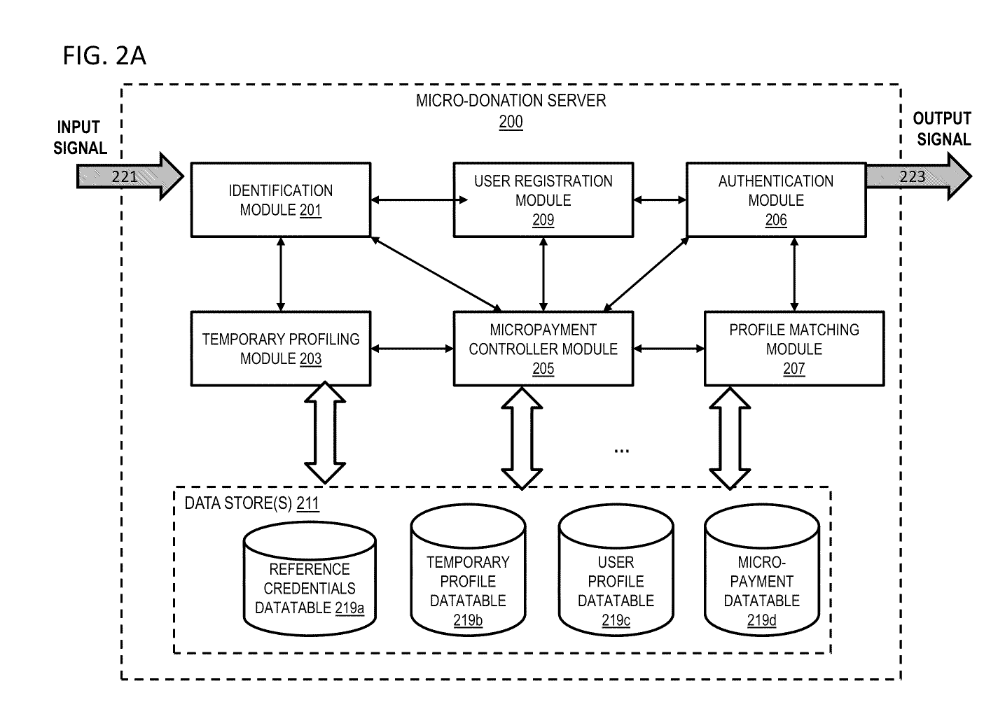

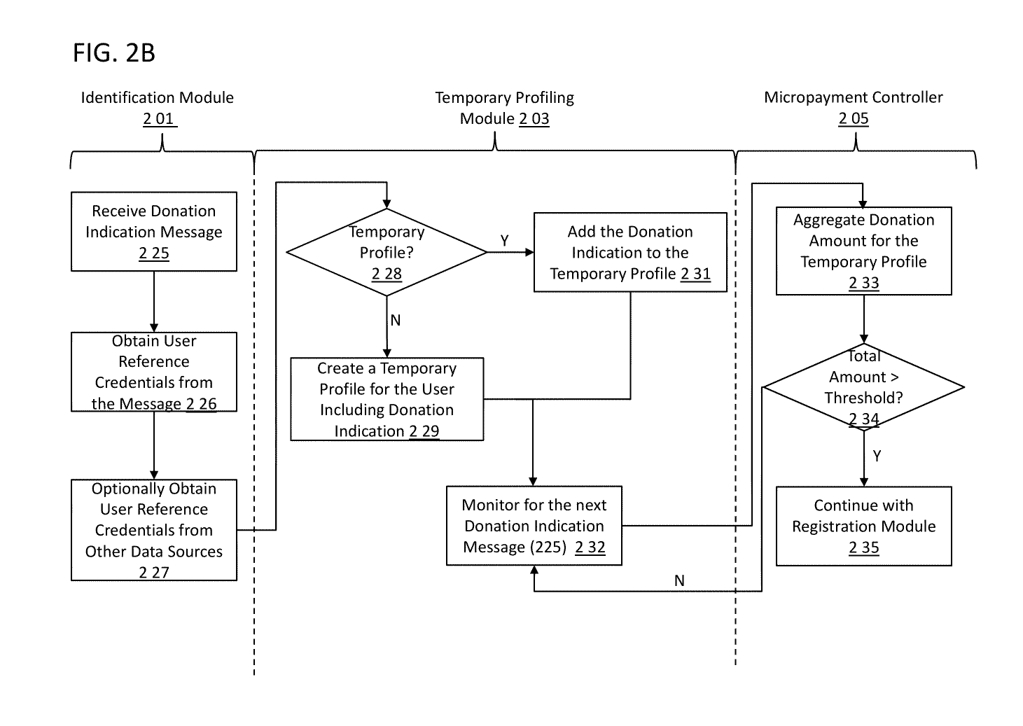

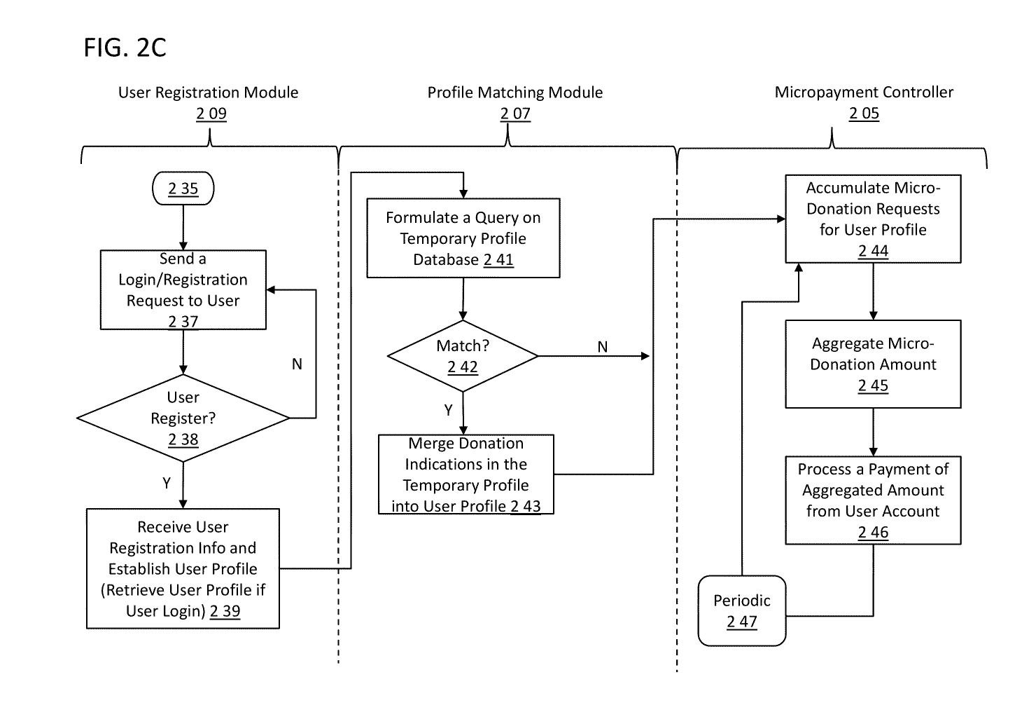

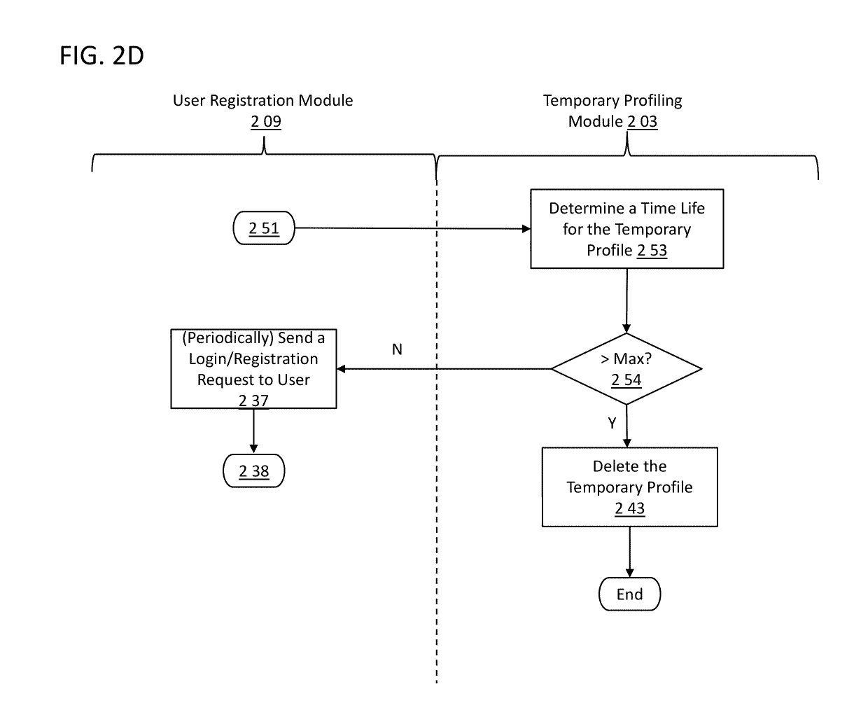

For example, the PDGS can provide a web widget such as a payment sandbox or button, to a website, which may appear as a “tip” or “pay” logo or icon (hereafter “BADGE”) attached on the webpage, so as to allow a user to click on the BADGE to submit tips on the webpage. In this way, the PDGS can enable “tipping” on the internet, providing a mechanism for users who see value in online content to simply “leave a tip.” The PDGS then receives the “tipping” request, and enables transactions in which very small amounts of money (e.g., from a penny on up) can be accepted such that transaction costs can be reduced. Additional discussion on the micropayment processing can be found at the Micropayment Controller Module 205 in FIGS. 2A-2C.

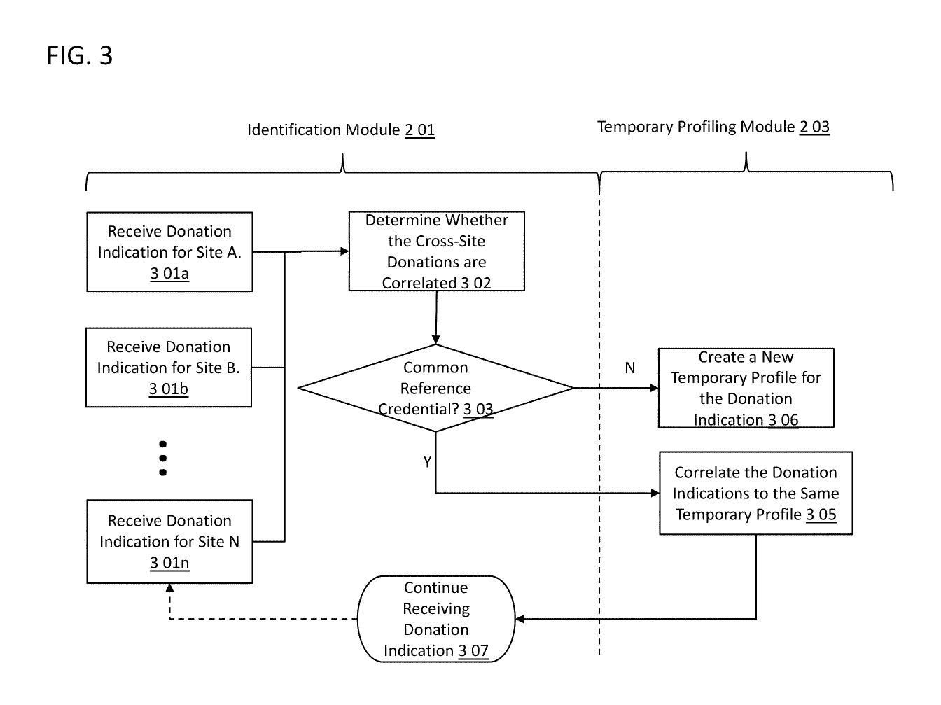

In another example, the PDGS enables a user to reward content that they like, with an amount of money that they control, and without having to establish an account with many different content providers or different payment systems. For example, a user may visit a webpage that has a payment BADGE, without having an account with the webpage, or any account with the PDGS. In this case, the user can click on the BADGE to indicate a reward. The PDGS can define a temporary profile for the user based on identification veracity credentials such as a session identifier, a browser identifier, an Internet Protocol (IP) address, user Internet activities, and/or the like. When the user elects to register with PDGS to establish an account to fulfill a payment (even after selection of the BADGE), the temporary profile can be matched and integrated with the registered user profile based on identification and authentication veracity. Further discussion on temporary profiling and identification veracity can be found below in connection with the Temporary Profiling Module 203, and Identification Module 201 in FIGS. 2A-2B and 3.

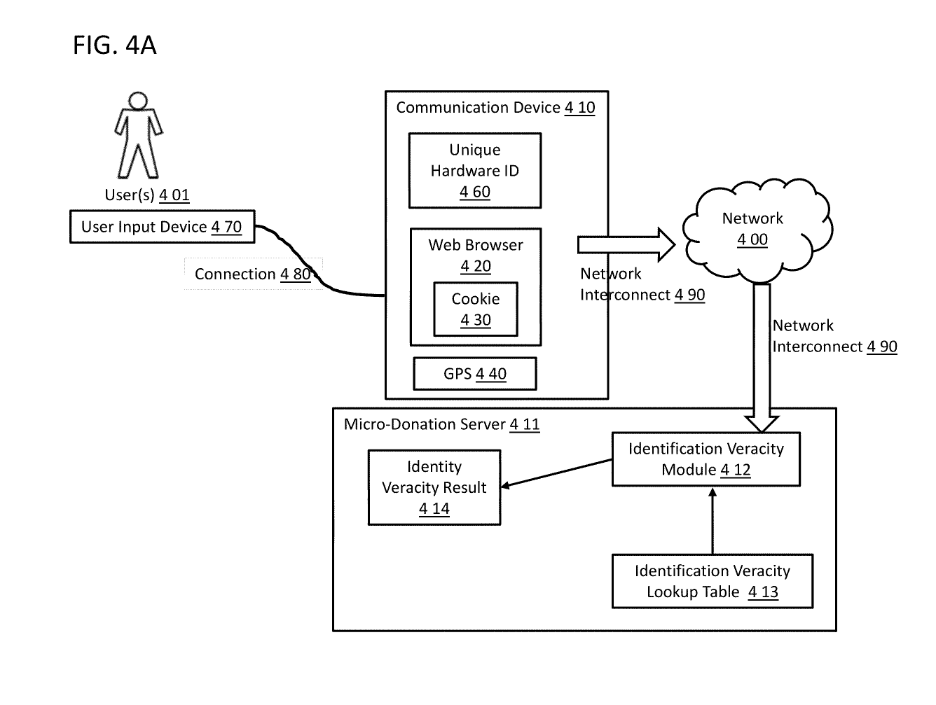

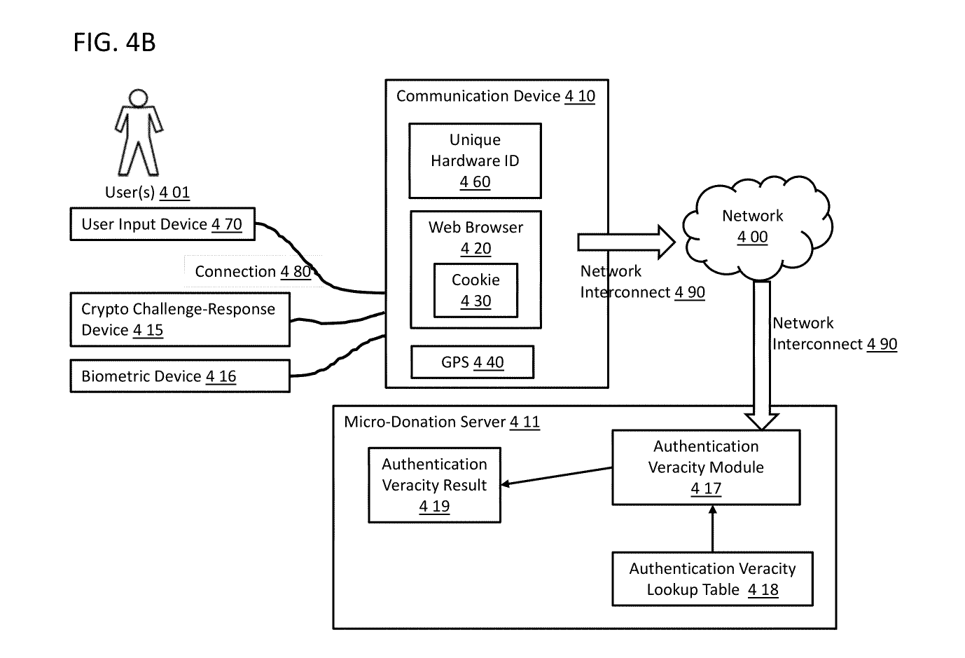

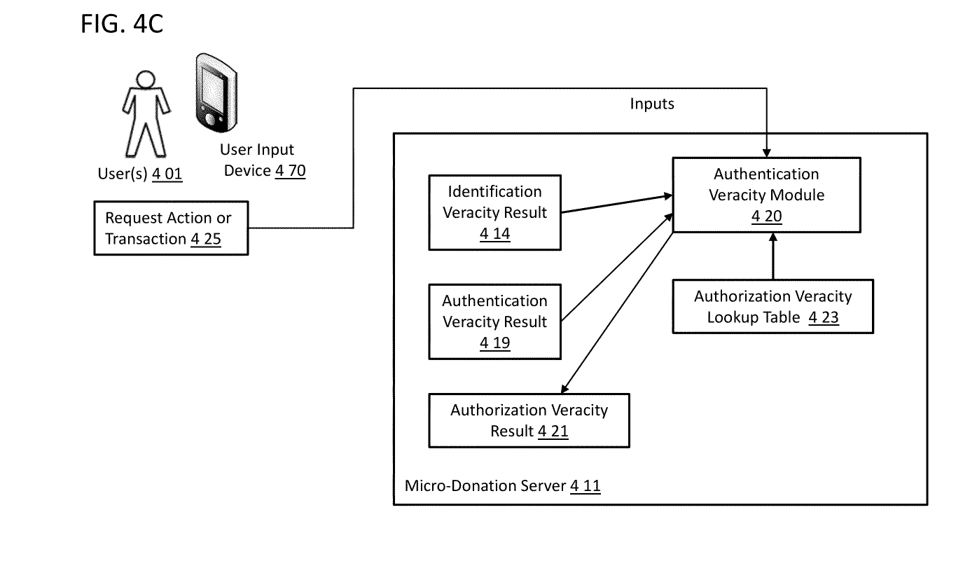

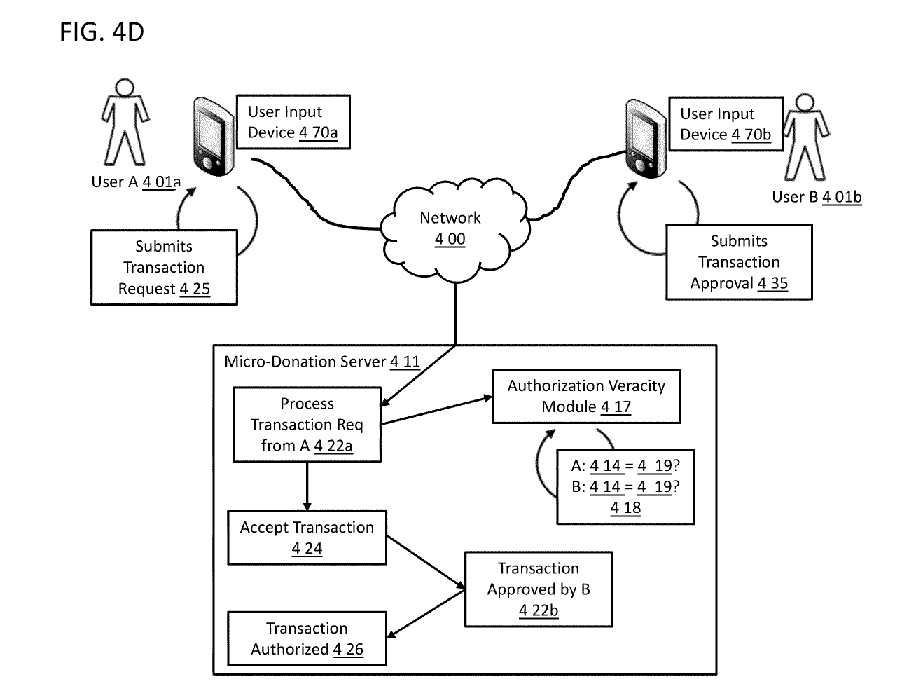

In another example, the PDGS uses the veracity of identification to link a registered user with the user's pre-registration transaction requests (e.g., a user can click to donate or tip even if the user is not registered with the donation site or PDGS, etc.), and/or uses the veracity of authentication to validate a registered user, e.g., the user is whom they claim to be. Further discussions on the identification veracity and authentication veracity are provided below in connection with the Identification Module 201 and Authentication Module 206 in FIGS. 2A-2B, and FIGS. 4A-4B.

In another example, the PDGS uses levels of veracity of user activity characteristics and credentials to determine which actions a user is authorized to perform within the PDGS, in addition to the basis of whether or not the user is identified and authenticated by the PDGS, e.g., whether the user has registered and/or has provided login credentials. A variety of mechanisms for identification (e.g., user browser identifier, user session identifier, user IP address, etc.) can each be considered to be of various levels of veracity (accuracy, or trustworthiness, or resistance to fraud, etc.) as compared to others; a variety of mechanisms for authentication (e.g., user hardware identifier, username and password combination, etc.) can be considered to be of various levels of veracity (accuracy, or trustworthiness, or resistance to fraud, etc.) as compared to others. The online system can use these respective veracity levels as data in the security authorization process. Further discussion on the authorization of a transaction request based on identification/authentication veracity is provided below in connection with the Identification Module 201 and Authentication Module 206 in FIGS. 2A-2B, and FIGS. 4C-4D.

In a further implementation, the PDGS enables comments & ratings by tippers, and information about the amounts and number of tips, to be attached to a copy or version of the web page or content being rated so that these appear as annotations. Users who have logged into the PDGS can view these annotations as an overlay; or alternatively, these annotations may be visible on a separate web page or application hosted by the PDGS. An Internet browser add-on application or widget can make these annotations viewable or non-viewable to users who have logged in the PDGS. In another embodiment, a user could leave a tip with a rating and comment, even if no BADGE is present on the web site, by logging into his or her PDGS account, by clicking an internet browser add-on application, or by clicking a PDGS widget.

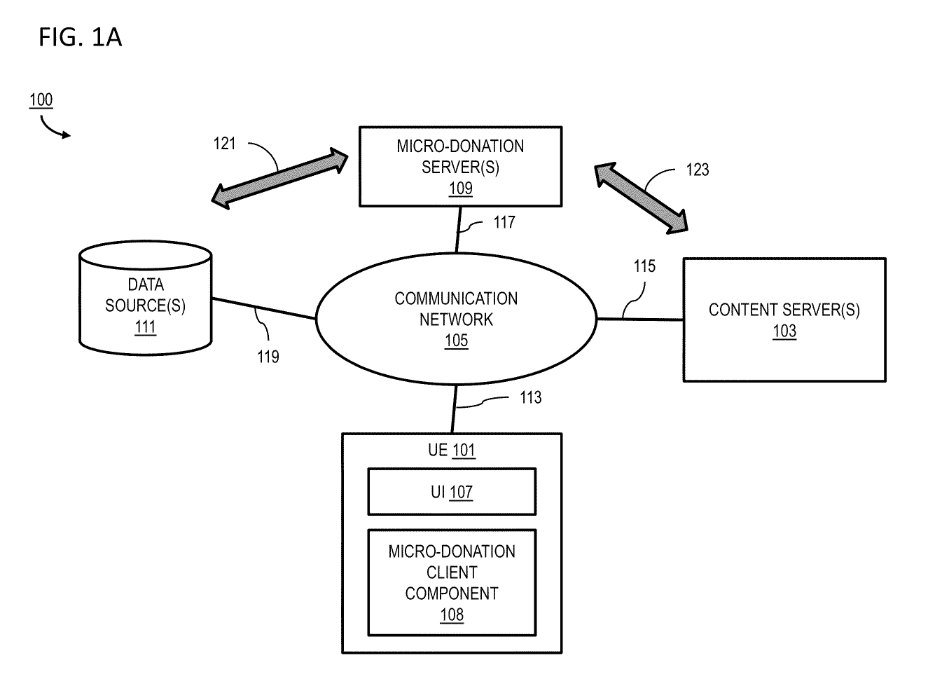

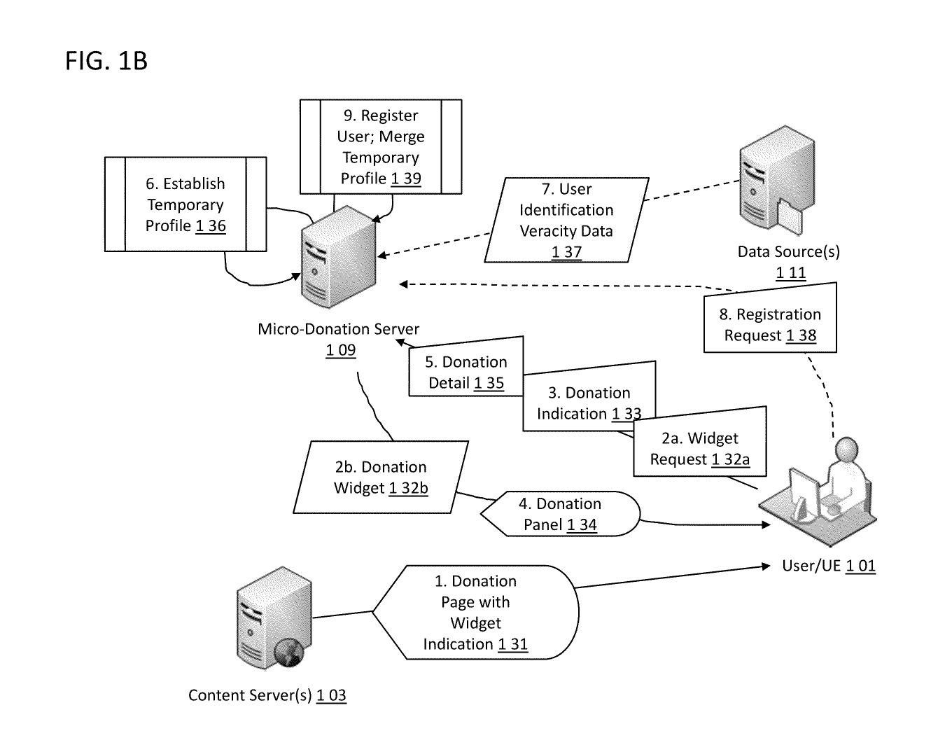

FIG. 1A is a schematic block diagram of a communication network system in which micro-donation functions can be provided, according to an embodiment. A communication network system 100 (e.g., a PDGS system) can include one or more user devices or User Equipment (UEs) 101, each equipped with at least a User Interface (UI) 107; one or more micro-donation server(s) 109 (e.g., a PDGS server); one or more data source(s) 111; and a content server(s) 103. Any of the devices or servers of the network system 100 can be equipped with local memory/storage spaces (not shown in FIG. 1A). Furthermore, the devices and servers of the network system 100 may have access to centralized or distributed memory/storage spaces (not shown in FIG. 1A) through the communication network 105. Thus, FIG. 1A is merely an example illustrating the types of devices and platforms that can be included within a communication network system 100.

Communication network 105 can be any communication network, such as the Internet, configurable to allow the one or more UEs 101, the one or more micro-donation servers 109, and the content server(s) 103 to communicate with communication network 105 and/or to each other through communication network 105. Communication network 105 can be any network or combination of networks capable of transmitting information (e.g., data and/or signals) and can include, for example, a telephone network, an Ethernet network, a fiber-optic network, a wireless network, and/or a cellular network.

In some instances, communication network 105 can include multiple networks operatively coupled to one another by, for example, network bridges, routers, switches and/or gateways. For example, the UEs 101 can be operatively coupled to a cellular network; and the content server(s) 103 can be operatively coupled to a fiber-optic network. The cellular network and fiber-optic network can each be operatively coupled to one another via one or more network bridges, routers, switches, and/or gateways such that the cellular network, the Ethernet network and the fiber-optic network are operatively coupled to form a communication network. Alternatively, the cellular network and fiber-optic network can each be operatively coupled to one another via one or more additional networks. For example, the cellular network and the fiber-optic network can each be operatively coupled to the Internet such that the cellular network, the fiber-optic network and the Internet are operatively coupled to form a communication network.

As illustrated in FIG. 1A, UEs 101 are operatively coupled to communication network 105 via network connection(s) 113; content server(s) 103 is operatively coupled to communication network 105 via network connection(s) 115; the micro-donation servers 109 are operatively coupled to communication network 105 via network connection(s) 117; and data source(s) 111 are operatively coupled to communication network 105 via network connection(s) 119. Network connections 113, 115, 117, and 119 can be any appropriate network connection for operatively coupling UEs 101, content server(s) 103, the micro-donation servers 109, and the data source(s) 111. Furthermore, the content server(s) 103 can have a direct connection with micro-donation server(s) 109 via a communication 123, and the micro-donation server(s) 109 can have a direct connection to the data source(s) 111 via communication 121.

A network connection can be a wireless network connection such as, for example, a wireless fidelity (“Wi-Fi®”) or Wireless Local Area Network (“WLAN”) connection, a Wireless Wide Area Network (“WWAN”) connection, and/or a cellular connection. A network connection can be a wired connection such as, for example, an Ethernet connection, a Digital Subscription Line (“DSL”) connection, a broadband coaxial connection, and/or a fiber-optic connection.

As mentioned above, in some instances, a communication network system 100 can include more than one UE 101, more than one micro-donation server 109, and more than one data source 111. A UE 101, and/or a search engine server 109, can be operatively coupled to the communication network 105 by heterogeneous network connections. For example, a first UE 101 can be operatively coupled to the communication network 105 by a WWAN network connection, another UE 101 can be operatively coupled to the communication network 105 by a DSL network connection, and a micro-donation server 109 can be operatively coupled to the communication network 105 by a fiber-optic network connection.

The micro-donation server(s) 109 each can be, for example, a web server, a financial payment server, a data center, and/or the like configured to provide search, data processing and aggregation, financial processing capabilities to electronic devices, such as UEs 101. The UE 101 can be in communication with the micro-donation server(s) 109 via the communication network 105, while the communication is managed by the content server(s) 103.

The content server(s) 103 can be a web site, blog, or other presenter of content that can place the BADGE on their web site, or associate it with content in their content management system, e.g., as advertising can be associated. The content consumer (user) sees the BADGE icon and can decide to click on it and “tip” the content provider.

For example, a user operating a UE 101 can access the content server(s) 103 (e.g., a content webpage having a “tip” or “donate” BADGE icon displayed, etc.), via which to send a “tip” or “donation” request, and such request will be sent to the micro-donation server 109 via the communication network 105. In another example, the micro-donation server 109 may communicate with the content server(s) 103 directly with a communication link 123, e.g., when the content server(s) 103 is integrated with the micro-donation server 109.

The UEs 101 can be any of a variety of electronic devices that can be operatively coupled to communication network 105. A UE 101 can be a personal computer, a tablet computer, a personal digital assistant (PDA), a cellular telephone, a portable/mobile internet device, television, kiosk display, display screens in vehicles, projection devices, laser display devices, digital display watches, digital display glasses and/or some other electronic communication device with audio and/or visual capabilities. A UE 101 can also be a television set, a streamer device, a set top box, or any other electronic device equipped with a display unit (a UI 107) and a network connection 113 that enables the device to run applications on an operating system. A UE 101 can be operatively coupled to communication network 105 via the UI 107 and network connection 113. The UEs 101 each can include a micro-donation client component 108 (e.g., a web browser, a mobile application, etc.) configured to access a webpage or website hosted on or accessible via the content server(s) 103 over communication network 105. The UEs 101 can be configured to support, for example, Hyper Text Markup Language (HTML) using JavaScript. For example, the UEs 101 can include a web browser, such as, Firefox®, Safari®, Dolphin®, Opera®, Internet Explorer (IE) °, and Chrome®. An Internet page or website can be accessed by a user of a web browser at a UE 101 by providing the web browser with a reference such as a uniform resource locator (URL), for example, of a webpage. For example, a user of a UE 101 can access a content server(s) 103 or a micro-donation server 109 via a URL designated for the content server(s) 103 or the micro-donation server 109, respectively.

In some instances, UEs 101 each can include specialized software other than a browser for accessing a remote server such as, for example, a micro-donation server 109. Specialized software can be, for example, a specialized network-enabled application or program provided by the micro-donation server 109. In some instances, portions of a website accessible via a web server can be located in a local or remote memory space/data store accessible to the web server.

In some instances, transaction log and demographic data can be sent from the micro-donation server 109 to the UE 101 as authorized by the user in their account profile, at the time of payment or another time.

Data source(s) 111 can be data sources distributed throughout the communication network system 100. A data source 111 can be at least one of a database, a data warehouse, a file, etc. A UE 101 can also include a display, monitor or user interface (UI) 107, a keyboard, various ports (e.g., a USB port), and other user interface features, such as, for example, touch screen controls, audio components, and/or video components (each not shown). For example, the data source(s) 111 can include cloud services and/or other scalable technical data services like data processing, storage, input/output, and processing-on-demand to aggregate user data obtained from the Internet. As another example, the micro-donation server 109 can obtain third party user credentials from data sources 111 such as social media (e.g., Facebook, etc.) and other internet sites and services (e.g., Amazon, etc.), such as “login with Facebook/Amazon” tools, and take advantage of any of relevant analytics, advertising accounting and control functions from such social media platform.

FIG. 1B is a data flow diagram illustrating aspects of interactive data flows between a micro-donation server 109 and related entities, according to an embodiment. As shown at FIG. 1B, the micro-donation server 109, the data source(s) 111, the user/UE 101, and the content server(s) 103 (as discussed in FIG. 1A) may interact and exchange data messages (e.g., data messages 131-134 and 136) for handling micro-donations from unknown/unregistered users.

In one implementation, a content server(s) 103 may provide a donation page with a donation widget indication 131 (e.g., the donation page can include a block of code that link the donation page to the micro-donation server 109 to download a donation widget) to a user operating a UE 101. Upon a user accessing the content site hosted by the content server 103, the user/UE 101 may send a widget request 132a to the micro-donation server 109, which may in turn provide a predefined donation widget 132b (linked to the micro-donation server 109) to the user/UE 101. For example, the widget on the donation page may include a donation/tipping button, and/or a donation/tipping panel including various options for a user to choose, e.g., “show me the tip levels that are currently set” or “show me the history that I have with this content provider” or, “tip this provider” by clicking on one of the displayed rating stars.

When the user 101 clicks on or selects the BADGE icon, a message representing a donation indication 133 is communicated back to the micro-donation server 109. For example, the micro-donation server 109 may provide a real time communication with the content server(s) 103, either “in channel” with the current transaction session on the Internet, or via another connection to a different application at the user/UE 101. The micro-donation server 109 may in turn provide a donation panel 134 for the user 101 to select from, e.g., donation amount levels, and/or the like. The user/UE 101 can submit donation details 135 indicating a donation amount, e.g., by transmitting a communication message including the donation details 135 to the micro-donation server 109. In some instances, the donation detail 135 and/or the donation indication 133, as sent in one or more communication message(s) from the UE 101, can include identification veracity data, or a “reference identifier” of the user/UE 101 (e.g., instead of credentials identifying a user personally, identifiers that references the donation indication, such as a browser identifier, an IP address, a session identifier, and/or the like). Or the micro-donation server 109 may optionally obtain additional user identification veracity data 137 from the data source(s) 111. The user identification veracity data 137 (also referred to as identification parametric data) includes data by which a user can be identified using one (or more) of several identification mechanisms. Examples identification veracity or parametric data include a particular computer identified by a hardware identifier unique to the computer; a “user name” or “user id” entered by the user at an attached keyboard or input device; a geographic location determined using a sensor input such as GPS; or a web browser cookie from a previous interaction with micro-donation server.

The micro-donation server 109 may establish a temporary profile (at 136) including user identification veracity data 137, the donation indication 133 and/or the donation detail 135. In particular, when the user is unknown or unregistered, the donation process can be secure and flexible for the user as the user does not need to provide identifiable information of himself or herself. In this way, unregistered users can start using the donation mechanism, e.g., to start a “leave a tip” transaction without having to register first.

In some instances, a user can elect to register with the micro-donation server 109, e.g., to fulfill the donation payment. Or alternatively, the micro-donation server 109 may request an unknown user to register when the unknown user has accumulated a threshold amount of donations (e.g., $10.00, $20.00, etc.) in the temporary profile. The user can submit to the micro-donation server 109 a registration request 138, which includes the user's personal identifying profile information (e.g., name, address, contact information, etc.), and financial payment information (e.g., a credit card account, a checking account, a PayPal account, etc.). Upon user registration, the micro-donation server 109 can merge the temporary profile (including the donation indication 133 as part of the temporary profile) into the user profile, e.g., at 139. For example, the micro-donation server 109 can compare the user's identification veracity data (e.g., a reference identifier such as a computer hardware identifier, a browser identifier, etc.) with the user's login credentials, and/or authentication data, to determine whether a micro-donation indication associated with a temporary profile of an unknown/unregistered user is related to the registered user. In some instances, multiple temporary profiles can be merged with a single user's profile, e.g., when each temporary profile is associated with a respective hardware identifier as the user made the respective donation on different devices, but the user later logged into the same account on different devices. Thus the micro-donation server 109 may authorize the micro-donation indication as a transaction request on behalf of the registered user. Further discussion on the transaction authorization based on veracity data is provided in FIGS. 4C-4D.

FIG. 2A is a schematic illustration of a micro-donation server, according to an embodiment. The micro-donation server 200 can be similar to the micro-donation server 109 of FIGS. 1A-1B. As shown in FIG. 2A, a micro-donation server 200 can include an identification module 201, a temporary profiling module 203, a user registration module 209, a micropayment controller module 205, an authentication module 206, a profile matching module 207, and one or more data store(s) 211. A data store(s) 211 can include a reference (or veracity) credentials datatable 219a, a temporary profile datatable 219b, a user profile datatable 219c, a micropayment datatable 219d, and/or the like. Furthermore, the micro-donation server 200 communicates with other devices of a communication network system (e.g., communication network system 100 of FIG. 1A) via input signal 221 and output signal 223. For example, the input signal 221 can include a micro-donation indication message (e.g., 133 in FIG. 1B) from a user device; an output signal 223 can include a financial transaction request for aggregated micropayments (e.g., as further discussed at 246 in FIG. 2C) to a financial network (e.g., Visa, American Express, and/or the like).

In various instances, the micro-donation server 200 and its components can be located anywhere within a communication network system 100 such as that shown in FIG. 1A including, but not limited to, within the UEs 101, or in separate locations within the communication network system 100 of FIG. 1A. The micro-donation server 200 can also be provided as on-premise deployment, via private computation clouds, or be embedded into other software or bundled into devices by Original Equipment Manufacturers (OEMs).

As used herein, a module can be, for example, any assembly and/or set of operatively-coupled electrical components, and can include, for example, a memory, a processor, electrical traces, optical connectors, software (executing or to be executed in hardware) and/or the like. Furthermore, a module can be capable of performing one or more specific functions associated with the module, as discussed further below.

In some instances, the micro-donation server 200 receives an input via the input signal 221 representing a micro-donation indication (e.g., 133 in FIG. 1B). The micro-donation indication can be processed by the identification module 201 to extract user reference credentials and/or identification veracity data.

In some instances, the temporary profiling module 203 can receive identification veracity data from the identification module 201, and define a temporary profile for the identified reference credential (e.g., a browser identifier, a session identifier, etc.) including the micro-donation request. The temporary profiling module 203 may store the temporary profiles at the datatable 291b, so that when a new micro-donation request is received from that unregistered user, the temporary profiling module 203 can match the new micro-donation request with an existing temporary profile in the datatable 219b, and add such micro-donation request to the temporary profile. Further function and capabilities of the temporary profiling module 203 are discussed in FIGS. 2B-2D and 3.

In some instances, the user registration module 209 can prompt a user to register with the micro-donation server 200 (and/or the PDGS system). The user registration module 209 may receive user identifying information (e.g., user name, password, user email, user address, etc.), and optionally financial payment information (e.g., a credit card number, a checking account number, a PayPal account, etc.), and create a user profile to store at the user profile datatable 291c. In some instances, the user may not provide financial payment information at the time of registration, but provide financial information at the first payment.

In a further example, the registration module 209 prompts (e.g., by providing a registration page via a user interface, etc.) a user to register for an account with an associated profile. Example information the registration module 209 can obtain from the user includes their name, address, email, phone number, tipping “username” pseudonym, and social media identification information (e.g., identification used for third party system such as Facebook, LinkedIn, Pinterest, Twitter, Tumblr, and other social media accounts). The registration module 209 may further prompt the user to register for a financial payment method, e.g., how the user will pay for their tips. The user can select privacy options to determine what information about themselves they are willing to share with other users and/or a donation site (e.g., the content server(s) 103).

Upon registration, a user can request to view links to other tippable content that are similar to the content server(s) 103 they have tipped. The user can request to view links to other tippable content, tipped by other users that are similar to themselves or who have similar interests (e.g., the micro-donation server 109 can perform analytics to determine “similar” users to an instant user, based on their tipping/donating history, etc.). The user can request to view links of tippable content marked for special matching programs, incentives, or charity contributions. The user can leave a tip or a comment, and/or request to view information about the tips or ratings or comments that other users have left for a particular piece of content. The user can retrieve transactional and summary data regarding their tipping activity and their comments, and/or review transactions that have been identified as requiring additional information, verification, or approval to be processed. After registration but without login to the micro-donation server 109, the user can interact with a donation widget (e.g., the BADGE) without providing full user identifier and password authentication.

Upon user registration and login, the micro-donation server 200 can collect tip event data, and record the transactional data. The micro-donation server 200 can further determine the degree/level of authentication of a tip event (should the tip be marked as “potential”, or “pending”, etc.), and appropriately mark the account ledgers of users and content server(s). The micro-donation server 200 can perform periodic end-of-month financial processing. For example, the micro-donation server 200 determines which tips are valid (state “payout pending”), which tips should be rejected, which tips require user input, which tips require content server(s) input, and/or the like. The micro-donation server 200 may further bill users using his or her registered payment methods, and process payments to content server(s) 103.

In a further implementation, a user can “pre-fund” a donation account with the micro-donation server 200. For example, a user can open a PDGS account via the user registration module 209 and arrange for payment into the account to be made on an occasional or automatic basis, e.g., in a similar fashion to the account for a car “E-Z Pass” device with which a driver can pay tolls. The user registration module 209 allows a user to automatically refill the account so that some pre-set amount is kept in it, for example, $20. Those funds are drawn upon to fund the user's donation and/or tipping activities, and when the amount in the account gets to a minimum amount, e.g., $0.5, then the user registration module 209 may automatically initiate a transaction from the user's linked financial payment account (e.g., a credit card account, a checking account, a PayPal account, etc.) to top the account off at $20 again, or to add a pre-set amount to the account. The user sets up his or her account with their personal “tip profile” which states what the various settings or “clicks” on the “BADGE” on the web site will be worth—as an example, this could be a set of 5 stars, each of which means a different amount of tip. The user could set those stars to mean from $0.01 to $0.05, with one star representing a penny, two stars representing two cents, etc. Alternately, the user could set the stars to mean that one star is $0.01, two stars are $0.05, three are $0.10, four are $0.25, and 5 are $1.00; or in another example 1 star is $0.05, 2 stars are $0.70, 3 stars are $1.25, 4 stars are $1.75, and 5 stars are $2.00; or the settings can be for any amount of money.

In a further implementation, upon user registration, when a user encounters a BADGE icon on a web site, or other content presentation, the user can click on or select a “star” (e.g., representing different levels of donation amounts, etc.) on the BADGE to automatically “tip” just that piece of content, or to tip that “site”, the amount that is defined for that star(s). In doing so, the user is rewarding the content server(s) 103 with the tip money (minus handling fees), and the user is also rating the site on that 1-5 scale established by the stars.

In some instances, the profile matching module 207 is configured to match a temporary profile in the temporary profile datatable 219b with a defined user profile in the user profile datatable 219c based on shared common identification reference credentials. The profile matching module 207 interacts with the identification module 201 and authentication module 206 to authorize a transaction request based on identification and/or authentication veracity data. Further details of the profile matching and/or authorization based on veracity data are provided in FIGS. 4C-4D.

In some instances, the authentication module 206 uses authentication parametric data (hereinafter “APD”) to authenticate a registered user, e.g., in combination with the identification veracity data stored at the reference (or veracity) credentials datatable 291a. Example APD includes: a secret user password, or a Personal Identification Number (hereafter “PIN”), or an entry from a pre-calculated pad of one-time use passwords, or the output from a cryptographic challenge-response device, which is entered by the user at an attached keyboard or input device; or a physical biometric reading is performed, of fingerprint(s), or a retina is scanned, or other biometric parameters obtained by the authentication module 206. Successful validation of the entered authentication information completes the authentication process: the user is authenticated or “logged in,” and the user may proceed to interact with the micro-donation server 200 via the UE 101. A variety of alternatives can be employed by the authentication module 206 to vary or strengthen the authentication process (e.g., one-time passwords, challenge-response protocols using time-based cryptographic tokens, fingerprint scanning, iris/retina scanning, etc.). Authentication procedures adopted by the authentication module 206 can implement a Boolean (two-state) authentication process based on the veracity inputs, by which the user is either: identified and “logged in” (registered); or, unknown and “not logged in” (unregistered). Upon authentication, the authentication module 206 can authorize the micropayment controller module 205 to process a transaction request.

In some instances, the micropayment controller module 205 may process any micro-donation indication and/or transaction request in a micropayment processing mechanism. For example, the micropayment controller module 205 accumulates tips/donation amounts directed to the content server(s) 103, and transfer that accumulated amount to an account associated with the content server(s) 103, when the accumulated amount exceeds a threshold (e.g., $10.00 minimum etc.). On the other hand, the micropayment controller module 205 accumulates a user's donation/tipping amount, and deducts the accumulated amount from the user's account when the accumulated amount reaches a threshold (e.g., $10.00 minimum). The micropayment processing can occur periodically; and/or under user control; and/or in a batch, e.g., at the end of each calendar month or any other agreed-upon time period. The micropayment controller module 205 initiates a fund transfer of accumulated amounts to the content server(s) 103, and/or deducts an accumulated amount from the user's account. In this way, because the financial transaction takes place in a batch with an accumulated amount, the user and/or the content server(s) 103 do not need to pay a transaction fee for every micro-donation.

FIGS. 2B-2D are logic flow diagrams illustrating interactions between various functional modules of the micro-donation server for aspects of pre-registration user donation indication processing, temporary profiling and post-registration micro-donation processing, respectively, according to an embodiment. In one implementation, the micro-donation server and/or the content server(s) enable unknown or unregistered users to start making a donation—for example, to start a “leave a tip” transaction —without having to register first. As shown in FIG. 2B, when the identification module 201 at the micro-donation server receives a donation indication message at 225, e.g., from a device of an unknown or unregistered user, the identification module 201 may obtain user reference credentials from the micro-donation indication message at 226, such as a device hardware identifier, a browser identifier, a session identifier, and/or the like, which may not identify the user personally. The identification module 201 may optionally obtain user reference credentials and/or identification veracity data from other data sources at 227, such as, but not limited to user login credentials to a third-party platform (e.g., social media, etc.) that is stored in the web cookie, and/or the like.

Upon obtaining the micro-donation indication and the associated user reference credential/identification veracity data from an unregistered user, the temporary profiling module 203 determines whether a temporary profile already exists for the unregistered user at 228. For example, the temporary profiling module 203 may query a temporary profiles datatable (e.g., 219b in FIG. 2A) based on a user reference identifier (e.g., a browser identifier, a device hardware identifier, a session identifier, etc.). If a temporary profile already exists associated with the user reference identifier, the temporary profiling module 203 may add the donation indication to the queried temporary profile at 231. Otherwise, the temporary profiling module 203 may define a temporary profile including the donation indication, and any reference credentials and/or identification veracity data associated with the indication, at 229. The temporary profiling module 203 can use multiple levels of identification veracity and/or multiple user reference credentials to determine whether an existing temporary profile is associated with a new donation indication. For example, different users can use the same computer to submit donation indications, resulting in a series of donation indications having the same hardware identifier and/or IP addresses; and thus different session identifiers of these donation indications can indicate these donation indications should not be added to the same temporary profile. Further discussion on handling identification based on veracity data is provided in FIG. 4A.

The temporary profiling module 203 continuously monitors the next donation indication message at 232. Once a donation indication is processed with the temporary profiling module 203 as described at 228, 229/231, the micropayment controller 205 aggregates the donation amount for each donation indication associated with a given temporary profile at 233. If the total amount is greater than a predetermined threshold (e.g., $10.00, $20.00, etc.) at 234, the micropayment controller 205 will have the unknown or unregistered user to fulfill the payment, and continues with the registration module at 235. If the total amount is less than the predetermined threshold, the micropayment controller 205 can keep allowing the unregistered user to submit donation indications without registering and/or providing financial information to fulfill the donation, e.g., at 232.

Continuing on with FIG. 2C, the user registration module 209 can send a login/registration request to the user at 237, e.g., when an unknown user has accumulated micro-donation amounts up to a predetermined threshold. If the user elects to register at 238, the user registration module 209 receives user registration information from a user compute device, and establishes a user profile including user identifying information and user financial payment information at 239. If the user elects not to register at 238, the micro-donation server may not allow the user (with the same reference identifier, e.g., a browser identifier, etc.) to continue clicking to donate, but repeatedly prompting the user to register at 237 until the user registers.

Upon establishing a user profile (or user providing login credentials if the user has already registered), the profile matching module 207 formulates a query on the temporary profile database at 241, to retrieve previously stored donation indications that may be matched with a user profile. The profile matching process can be performed with a combined identification veracity and authentication veracity verification process, e.g., to verify a user providing authentication credentials is the same person who has submitted a donation/transaction request prior to login or registration (as further illustrated in FIGS. 4C-4D). If a match between a temporary profile and a registered user profile is found at 242, the profile matching module 207 merges donation indications in the temporary profile into the user profile at 243, and proceeds with micropayment processing. If no match is found, the method proceeds from the profile matching module 207 to the micropayment controller 205 to process micro-donations when any are under the registered user profile.

In one implementation, after a user has registered and/or authenticated by the micro-donation server, the micropayment controller 205 accumulates micro-donation requests made by the user at 244, and aggregates the micro-donation amount under the user profile at 245. When the aggregated amounts exceed a predetermined threshold (e.g., $20.00, etc.), the micropayment controller 205 processes a payment of the aggregated amount from the registered user's financial account (e.g., a credit card account, a checking account, a PayPal account, etc.), at 246. The micropayment controller 205 can be configured to periodically monitor and process aggregated micropayment requests, e.g., at 244-247.

Continuing on with FIG. 2D, as an unknown or unregistered user can click on a BADGE on a donation site to submit a donation indication, the users are more secure as they can anonymously browse a site and tentatively pay/donate/tip the content because the micro-donation server does not have identifiable information to personally trace the individual user. Therefore, a user can click to donate without registration, and withdraw from the tentative donation indication without paying or identifying themselves. For example, as shown in FIG. 2D, the temporary filing module 203 can determine a lifetime for a temporary profile at 253, e.g., how long the temporary profile has been defined without being identified with a registered user. If the lifetime exceeds a maximum (e.g., 15 days, 30 days, 60 days, etc.) at 254, the temporary profile module 203 can delete the temporary profile and release the memory space, at 243. Otherwise, the user registration module 209 may periodically send a login/registration request to the unknown user at 237, which proceeds at 237 in FIG. 2C.

FIG. 3 is a logic flow diagram illustrating aspects of correlating pre-registration user donation indications across different sites, according to an embodiment. As shown in FIG. 3, the identification module 201 may receive multiple donation indications from one or more unregistered users, each of which is associated with a different site at 301a-n, and determine whether the cross-site donations are correlated at 302, e.g., associated with the same unregistered user. If the multiple micro-donation indications share common reference credentials at 303, the temporary profiling module 203 correlates the donation indications to the same temporary profile at 305. For example, the identification module 201 can identify a correlation when different levels of shared reference credentials match between micro-donation indications, e.g., different users can use the same computer and thus the micro-donation indications share the same hardware identifier but different browser/session identifiers, etc. Otherwise, the temporary profiling module 203 defines a new temporary profile for each donation indication at 306. The identification module 201 continues to receive donation indication at 307.

FIGS. 4A-4D provide embodiments of using veracity data to authorize an unknown micro-donation indication with a user profile (e.g., with authentication credentials), and/or complete a micro-donation transaction. For example, by increasing the veracity of identification user's prior transactions can be linked. Similarly, by increasing the authentication veracity, the micro-donation server (e.g., the authentication module 206 in FIG. 2A) can validate whether a user is whom the user claims to be.

The veracity level is an input into the process of granting authorization to the user to perform certain actions (e.g., determined by business rules). In one embodiment, the micro-donation server can determine the veracity of identification and authentication by rating the information about the user during interaction with the user (e.g., when the user browses on a donation site via the content server(s) 103, clicks on the donation BADGE, etc.), and information about other users are used to link together the information about a user. For example, if a browser fingerprint indicates that the user's browser has been used by more than one user or that some tips were disavowed after a user was authenticated, then it lowers the identification veracity of tips from that browser, similarly a mobile device which has only ever had a single user on it has intrinsically higher identification veracity.

FIG. 4A is a schematic block diagram illustrating aspects of identification module (e.g., 201 in FIG. 2A) and its interaction with related entities, according to an embodiment. As shown in FIG. 4A, a customer or user 401 connects using a user input device 470, with a communication device 410, which may optionally include one or more of: an embedded web browser 420, which may contain and process a software data packed such as a “web cookie” 430; a location-sensing device 440 (e. g. GPS radio signal receiver) in an embedded implementation, or connected by local wires or wiring harness 480; an embedded unique hardware identifier 460; a user input device (e. g. keyboard, trackball, tablet surface) 470, which is connected, for example, by keyboard or other appropriate cable 480, or by wireless connection. The communication device 410 is connected by a network interconnect 490 (e. g. wired or wireless) to one or more networks 400, which are further connected to a micro-donation server 411 (e.g., which can be similar to the micro-donation server 109 in FIG. 1A, or 200 in FIG. 2A). To perform the veracity-based Identification (e.g., at the identification module 201 in FIG. 2A), the identification data inputs from the hardware device 410 are sent using the network 400, where the inputs are processed by the Identification Veracity Module 412, using data from the Identification Veracity Look-up Table 413, to produce an Identification Veracity Result 414 for this specific user 401 and hardware device 410 context (e.g., whether the user 401 and the device 410 can be associated with any temporary profile).

In some instances, the module 412 compares different identification veracity data to determine whether different micro-donation indications are associated with a same user (if the user is unregistered and unidentified), e.g., by referring to the Identification Veracity Look-up Table 413, which stores a list of “referenced” users associated with identification veracity data. For example, the Identification Veracity Look-up Table 413 may have an entry for temporary profile associated with a given browser identifier and a given IP address; identification veracity data having the same browser identifier and the same IP address can be assigned to the same entry.

FIG. 4B is a schematic block diagram illustrating aspects of authentication module (e.g., 206 in FIG. 2A) and its interaction with related entities, according to an embodiment. Authentication veracity deals with the likelihood that at any given authentication event, a user is likely to be who they say they are. For example, tipping while not logged in has no authentication veracity; logging in to the system with a password from an unknown machine has a higher veracity; logging in to the system with a password from a known machine again has veracity; using a multi-factor authorization token again has higher veracity.

As shown in FIG. 4B, a customer or user 401 connects using a communication device 410, which in addition to items mentioned in FIG. 4A, may also optionally include one or more of: a cryptographic challenge-response device 415 (e.g., embedded in the user's communication device 410; free-standing or hand-held); a biometric input device 416 (e.g. fingerprint scanner, eye retina scanner, voice analysis device) included in or separate from the communication device 410.

Upon user registration with the micro-donation server 411, the user can provide authentication credentials to login. Examples of “authentication data inputs” into the device 410 include: a user password, Personal Identification Number (PIN), or an entry from a pre-calculated pad of one-time use passwords; the output from a cryptographic challenge-response device 415, and/or biometric data as retrieved from a biometric input device 416.

To perform the Veracity-based Authentication (e.g., to verify the user's identity as the user logs in), the “authentication data inputs” from the hardware device 410 are sent using the network 400 to the micro-donation server 411, e.g., which includes the Authentication Module 206 as shown in FIG. 2A), where the inputs are processed by the Authentication Veracity Module 417, using data from the Authentication Veracity Look-up Table 418, to produce an Authentication Veracity Result 419 for this specific user 401 and hardware device 410 context (e.g., whether the user 401 can be properly authenticated). For example, the module 417 compares various levels of authentication veracity data (e.g., username, password, browser identifiers, hardware identifiers, biometric data, etc.) stored at the Authentication Veracity Look-up Table 418 to determine whether the user submitting login details should be authenticated.

FIG. 4C is a schematic block diagram illustrating aspects of authorizing a transaction request via identification and authentication modules (e.g., 201 and 206 in FIG. 2A), according to an embodiment. To perform the veracity-based authorization on behalf of a user's 401 requested action or transaction 425 (e.g., a micro-donation indication, etc.), the micro-donation server 411 (e.g., similar to the micro-donation server 109 in FIGS. 1A-1B) uses as inputs to an Authorization Veracity Module 420: the user identity, an Identification Veracity Result 414 (e.g., obtained at 414 in FIG. 4A) and other identification parametric data associated with the user, an Authentication Veracity Result 419 (e.g., obtained at 419 in FIG. 4B) and other authentication parametric data associated with the user, an Authorization Veracity Look-up Table 423 associated with this Authorization Veracity Module 420 and user context.

For example, the Authorization Veracity Module 420 adopts or implements various business rules to authorize an operation, such as:

i) web browser cookie (identification) and session was logged out or timed (no authentication): user can post a financial transaction, which may optionally (based on the online system business rules) require an additional authorization action;

ii) web browser cookie (identification) and session is actively logged in (PIN authentication): user can post a financial transaction up to a maximum monetary limit (e.g., $500.00, etc.; determined by the user profile and predefined online payment system business rules);

iii) web browser cookie (identification) and prior session was logged out or timed (no authentication) and additional PIN; user status changes from “logged out” to “logged in”, with all associated privileges of a logged in user who has an active session; or

iv) (a) web browser cookie or user name or user id (identification) and (b) password (authentication) user is authorized to perform all available operations, including the additional authorization action from a prior action.

As another example, a user with a session of lower-level veracity may begin an system request (e.g. request a payment transaction) with the micro-donation server, and have the system request accepted pending an occasion in which the same user performs an additional step to further authorize the transaction, for example, on an occasion when the user is connected to the system in a session of higher-level veracity.

One example of this scenario is an occasion in which a user with web browser cookie (identification) and no past session (no authentication) requests that a financial transaction be initiated. The financial transaction would then be pending, until an occasion in which the user enters sufficient veracity for the financial transaction to be processed. Until these additional veracity requirements are completed, the transaction would not be processed.

The authorization veracity module 420 produces a multi-value authorization veracity result 421, which is then used by the micro-donation server to “perform” (in the case of a result of True), or “deny” (in the case of a result of False), or “accept” (in the case of a result requiring additional action or authorization) the requested action or transaction by the user in the provided context. For example, the authorization veracity module 420 compares the identification veracity result 414 and the authentication veracity result 419 to associate a registered user's profile with the user's intended micro-donations stored as a temporary profile prior to registration. The authorization veracity module 420 may optionally produce additional trace or explanatory information (primarily as an aid to administrative users who are seeking to interpret or understand the reasoning and/or logic undertaking in producing the authorization veracity result 421.

FIG. 4D is a schematic block diagram illustrating aspects of authorizing/identifying a transaction request associated with two users via identification and authentication modules, according to an embodiment. As shown in FIG. 4D, a user “A” 401a is identified to an micro-donation server 411 (resulting in an identification veracity result 414 as described in FIG. 4A, and authenticated to the micro-donation server 411 (resulting in an authentication veracity result 419 as described in FIG. 4B.

A transaction request 425 (or a micro-donation indication received when a user is unregistered) is submitted to a micro-donation server 411 (e.g., the micro-donation server), e.g., at 422a. The authorization veracity module 417 may determine whether the identification veracity result 414 of user A matches with the authentication veracity result 419 for user A (e.g., at 418). If yes, the transaction can be accepted for user “A” 401a by incorporating the transaction request 425 into user A's profile (e.g., acknowledging the transaction request 425 is associated with user A, etc.), but not fully authorized (e.g., for execution, performance, or completion), at 424.

When another user “B” 401b is identified upon registration, and another transaction request 435 is submitted to the micro-donation server 411, and the transaction request 435 includes an indication to further process or complete the transaction 425 as previously submitted by “A” 401a, the transaction request 435 can act as a veracity level for the transaction request 425. The authorization veracity module 417 can then produce a result for user “B” 401b of “True” (at 422b), whereby the transaction 425 as previously submitted by “A” can be further processed or completed at 426.

It is worth noting that the user “A” 401a and user “B” 401b may actually be the same person, entity, or initiating source, but differ in another manner which would affect their identification veracity result 414 and an authentication veracity result 419, respectively. For example, the transaction request 425 from user “A” 401a may chronologically precede the transaction request 435 from user “B” 401b, so that the transaction request 435 can be viewed as the veracity level for transaction request 425.

An example of the authorization veracity module 417, would be a user who begins a transaction while logged into the micro-donation server using a PIN (lower veracity), and completes the transaction while logged into the micro-donation server using a password (higher veracity).

Another example of the authorization veracity module 417, would be a user who begins a transaction while logged into the micro-donation server (lower veracity, based on their job role responsibilities), and another user who completes the transaction while logged into the micro-donation server (higher veracity, based on their job role responsibilities). In another example, a minor who does not have his or her own funding capability may initiate a transaction request, and his or her parents can authorize and complete the transaction when the parents log in to confirm the transaction request.

Further examples of how the micro-donation server 411 (e.g., 109 in FIGS. 1A-1B) using the identification, authentication, and authorization veracity as discussed in FIGS. 4A-4D, include:

i) Using a previously-deposited web cookie in the data space of a web browser in a hardware device as identification input data (low veracity), the micro-donation server can be configured to authorize a user to perform an account status or account balance inquiry (low veracity), or confirm whether a previously-requested transaction has been completed (low veracity), or request a financial transaction (low veracity) (e.g., tip, payment, gift, or funds transfer), where the completion of the financial transaction may require an additional step or action by the same or another user in a higher-veracity context (e.g., confirmation from another user's request, as shown in FIG. 4D).

ii) Using a previously-deposited web cookie, and a PIN (Personal Identification Number) as identification input data (medium veracity), the micro-donation server can be configured to authorize a user to perform a request for issuance of a paper report using the existing registered user's postal or email address (medium veracity).

iii) Using a “user name” or “user id” and password as identification input data (high veracity), the micro-donation server can authorize a change in account contact information (high veracity), or perform a financial transaction (high veracity), or authorize the performance of a financial transaction (high veracity) which has been requested by a user (the same or a different user) from a lower-veracity session or context.

In a further example, a user who has been identified and authenticated at low-level veracity can begin a transaction (e.g., leaving a tip, gratuity, or donation) and follow up in time by a later action (by that same user or another user) identifying and authenticating in a higher-veracity way, to authorize the processing of that transaction.

In another example, a user can use a lower-level veracity identification and authentication for access to non-privileged actions or authorizations, and/or use a higher-level veracity identification and authentication for access to privileged actions or authorizations (e. g. administrative functions).

It is intended that the systems and methods described herein can be performed by software (executed on hardware), hardware, or a combination thereof. Hardware modules can include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Python, JavaScript, Objective-C, Swift, Perl, PHP, Visual Basic™, and other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

While various embodiments have been described above, it should be understood that they have been presented by way of example only, and not limitation. Where methods and steps described above indicate certain events occurring in certain order, the ordering of certain steps may be modified. Additionally, certain of the steps may be performed concurrently in a parallel process when possible, as well as performed sequentially as described above. Although various embodiments have been described as having particular features and/or combinations of components, other embodiments are possible having any combination or sub-combination of any features and/or components from any of the embodiments described herein.

What is claimed is:

1. A system, comprising:
a processor; and
a memory operatively coupled to the processor, the memory storing processor-readable instructions executable by the processor to:
receive, at a payment system associated with a payment widget displayed on a web page, upon engagement of the payment widget by a user, a communication message including a payment indication to transfer a payment amount to a payee;
determine the communication message originated from a user compute device before the user has registered with the payment system;
obtain, from the communication message, a reference identifier referencing the user;
generate a temporary profile including the reference identifier and information relating to the payment indication;
receive, subsequent to receiving the communication message, payment account information of the user after registration of the user with the payment system; and
automatically initiate a payment transaction for the payment indication from the temporary profile based on the payment account information.

2. The system of claim 1, wherein the payment widget includes any of a click button, a sandbox, a banner, or a ticker configured to display on a web page.

3. The system of claim 1, wherein the widget is associated with a web page that includes any of a donation request, a tipping request, or a purchase request.

4. The system of claim 1, wherein the communication message is received at a server that is configured to receive a plurality of communication messages associated with registered users and unregistered users of the payment system, and that is configured to aggregate payments.

5. The system of claim 1, wherein the reference identifier includes any of a browser identifier, a browser session identifier, a browser fingerprint, a hardware identifier of the user compute device, an Internet Protocol (IP) address of the user compute device, or a physical location of the user compute device.

6. The system of claim 1, wherein the processor-readable instructions are further executable by the processor to:
generate an integrated financial transaction request of an aggregated payment amount for a plurality of payment transactions when an aggregated payment amount for the plurality of payment transactions exceeds a predetermined threshold.

7. The system of claim 1, wherein the processor-readable instructions are further executable by the processor to:
determine a veracity of identification of the user based on the reference identifier; and
authorize the payment transaction for the payment indication based at least in part on the veracity of identification.

8. The system of claim 1, wherein the processor-readable instructions are further executable by the processor to:
receive a user input of authentication inputs after registration of the user with the payment system; and
authorize the payment transaction for the payment indication based at least in part on a veracity of authentication,
wherein the veracity of authentication including any of a secret user password, a Personal Identification Number (PIN), token-based authentication credentials, third-party authentication credentials, an entry from a pre-calculated pad of a one-time user password, or a physical biometric input.

9. The system of claim 1, wherein the communication message further including a user submitted comment relating to the payment indication.

10. A processor-implemented method, comprising:
receiving, via a user compute device, user registration information for a user, the user registration information being associated with a payment system and including user identifying information and user payment account information;
retrieving a previously stored temporary profile including a reference identifier that references the user prior to the user being registered with the payment system, and including a payment indication to transfer a payment amount to a payee;
correlating the previously stored temporary profile with the user registration information based on a match between the user registration information and the reference identifier; and
automatically initiating a payment transaction for the payment indication from the temporary profile based on the payment account information.

11. The method of claim 10, wherein the user identifying information includes any of a name of the user, a telephone number of the user, a password of the user, account information of the user provided by a third-party authentication mechanism or an address of the user.

12. The method of claim 10, wherein the user payment account information includes any of a credit card number, or a checking account number.

13. The method of claim 10, wherein the reference identifier includes any of a browser identifier, a browser session identifier, a browser fingerprint, a hardware identifier of a compute device of the user, an Internet Protocol (IP) address of the compute device, or a physical location of the compute device.

14. The method of claim 10, further comprising:
determining a veracity of identification of the user based on the reference identifier; and
authorizing the payment transaction for the payment indication based at least in part on the veracity of identification.

15. The method of claim 10, further comprising:
receiving a user input of authentication inputs after registration of the user with the payment system; and
authorizing the payment transaction for the payment indication based at least in part on a veracity of authentication,
wherein the veracity of authentication including any of a secret user password, a Personal Identification Number (PIN), token-based authentication credentials, third-party authentication credentials, an entry from a pre-calculated pad of a one-time user password, or a physical biometric input.

16. The method of claim 10, further comprising:
receiving a communication message including a user submitted comment relating to the payment indication.

17. A system, comprising:
a processor; and
a memory operatively coupled to the processor, the memory storing processor-readable instructions executable by the processor to:
receive, upon engagement of a first payment widget displayed on a first web page by a user via a first user interface, a first communication message including a first payment indication to transfer a first payment amount to a first payee;
obtain, from the first communication message, a first reference identifier to reference the user prior to the user being registered with a payment system associated with the first payment widget;
provide a second payment widget to a second web server for display on a second web page;
receive, upon engagement of a second payment widget displayed on a second web page by the user via a second user interface, a second communication message including a second payment indication to transfer a second payment amount to a second payee;
obtain, from the second communication message, the reference identifier that references the user prior to the user being registered with the payment system;
aggregate the first payment indication and the second payment indication to product payment information; and
generate a temporary profile for the user prior to the user being registered with the payment system, the temporary profile including the reference identifier and the payment information.

18. The system of claim 17, wherein the first payment widget and the second payment widget is each associated with a web page that includes any of a donation request, a tipping request, or a purchase request.

19. The system of claim 17, wherein the first payment amount and the second payment amount are micropayment amounts.

20. The system of claim 17, wherein the first communication message and the second communication message are received at a server that is configured to receive a plurality of communication messages associated with registered users and unregistered users of the payment system, and that is configured to aggregate payments.

21. The system of claim 17, wherein the reference identifier includes any of a browser identifier, a browser session identifier, a browser fingerprint, a hardware identifier of a compute device of the user, an Internet Protocol (IP) address of the compute device, or a physical location of the compute device.

22. The system of claim 17, wherein the processor-readable instructions are further executable by the processor to:
receive payment account information of the user after registration of the user; and
automatically initiate a first payment transaction for the first payment indication and a second payment transaction for the second payment indication from the temporary profile based on the payment account information.

23. The system of claim 17, wherein the first communication message further including a user submitted comment relating to the first payment indication.

24. A non-transitory processor-readable medium storing code representing processor-executable instructions, the code comprising code to cause the processor to:
receive, upon engagement of the payment widget by a user via a user interface, a communication message including a payment indication to transfer a payment amount to a payee;
determine the communication message originated from a user via a user compute device while the user is not registered with a payment system associated with the payment widget;
obtain, from the communication message, a reference identifier to reference the user without identifying information for the user;
generate a temporary profile including the reference identifier and information relating to the payment indication without payment account information for the user; and
delete the temporary profile when the user fails to provide user identifying information and user payment account information within a period of time after the communication message was received.

25. The medium of claim 24, wherein the reference identifier includes any of a browser identifier, a browser session identifier, a browser fingerprint, a hardware identifier of a compute device of the user, an Internet Protocol (IP) address of the compute device, or a physical location of the compute device.

26. The medium of claim 24, wherein the code further comprises code to cause the processor to:
send a registration request to the user compute device when an accumulated payment amount associated with the temporary profile exceeds a threshold amount.

27. The medium of claim 24, wherein the code further comprises code to cause the processor to:
receive, from the user compute device, an indication to withdraw the payment indication before the user is registered; and
delete the temporary profile in response to receiving the indication to withdraw.

28. The medium of claim 24, wherein the communication message further including a user submitted comment relating to the payment indication.
